(19) United States
(12) Patent Application Publication
(10) Pub. No.: US 2016/0023770 A1
(43) Pub. Date: Jan. 28, 2016

(54) AIR HEATING APPARATUS USEFUL FOR HEATING AN AIRCRAFT INTERIOR

(71) Applicants: NATHAN THOMPSON, HARRISBURG, SD (US); CURTIS KALLHOFF, SIOUX FALLS, SD (US)

(72) Inventors: NATHAN THOMPSON, HARRISBURG, SD (US); CURTIS KALLHOFF, SIOUX FALLS, SD (US)

(21) Appl. No.: 14/340,783

(22) Filed: Jul. 25, 2014

(51) Int. Cl. B64D 13/08

(52) U.S. Cl. CPC B64D 13/08; B64D 2013/0603

(57) ABSTRACT

An air heater apparatus may include a housing having an interior with an air path extending between an upstream air inlet in the housing and a downstream air outlet in the housing, and a motor mounted on the housing. The apparatus may also include a fan rotated by the motor and positioned in the air path to move air along the air path, an air heating assembly mounted on the housing and configured to heat air moving along the air path, and a gas detector being positioned in the air path in the interior of the housing and configured to detect a gas level in the air path.

### BACKGROUND

1. Field

The present disclosure relates to air heating apparatus and more particularly pertains to a new air heating apparatus useful for heating an aircraft interior while facilitating the avoidance of introducing an undesirable level of noxious gases into the interior.

2. Description of the Prior Art

The interior of an airplane needs to be maintained at a minimum level, such as a level so that the water onboard does not freeze) in cold conditions and climates. Heating the airplane interior by operating one or more of the aircraft engines on the ground for the sole purpose of maintaining the interior temperature is expensive and wasteful. Airlines have sought auxiliary apparatus to heat the aircraft cabin without having to operate the engines, and auxiliary heating devices have been adapted for this purpose, but are subject to drawbacks.

### SUMMARY

In one aspect, the present disclosure relates to an air heater apparatus that may include a housing having an interior with an air path extending between an upstream air inlet in the housing and a downstream air outlet in the housing, and a motor mounted on the housing. The apparatus may also include a fan rotated by the motor and positioned in the air path to move air along the air path, an air heating assembly mounted on the housing and configured to heat air moving along the air path, and a gas detector being positioned in the air path in the interior of the housing and configured to detect a gas level in the air path.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components, and particulars of the steps, set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of a new air heating apparatus useful for heating an aircraft interior according to the present disclosure, with panels of the housing removed to show detail of the apparatus in the interior of the housing.

FIG. 2 is a schematic side view of the apparatus, according to an illustrative embodiment, with panels of the housing removed to show detail of the apparatus in the interior of the housing.

FIG. 3 is a schematic top view of a portion of the apparatus, according to an illustrative embodiment, with panels of the housing removed to show detail of the apparatus in the interior of the housing.

FIG. 4 is a schematic block diagram of selected components of the apparatus, according to an illustrative embodiment.

FIG. 5 is a schematic block diagram of selected components of the apparatus, according to an illustrative embodiment.

FIG. 6 is a schematic flow diagram of an implementation of the operation of the apparatus, according to an illustrative embodiment.

### DETAILED DESCRIPTION

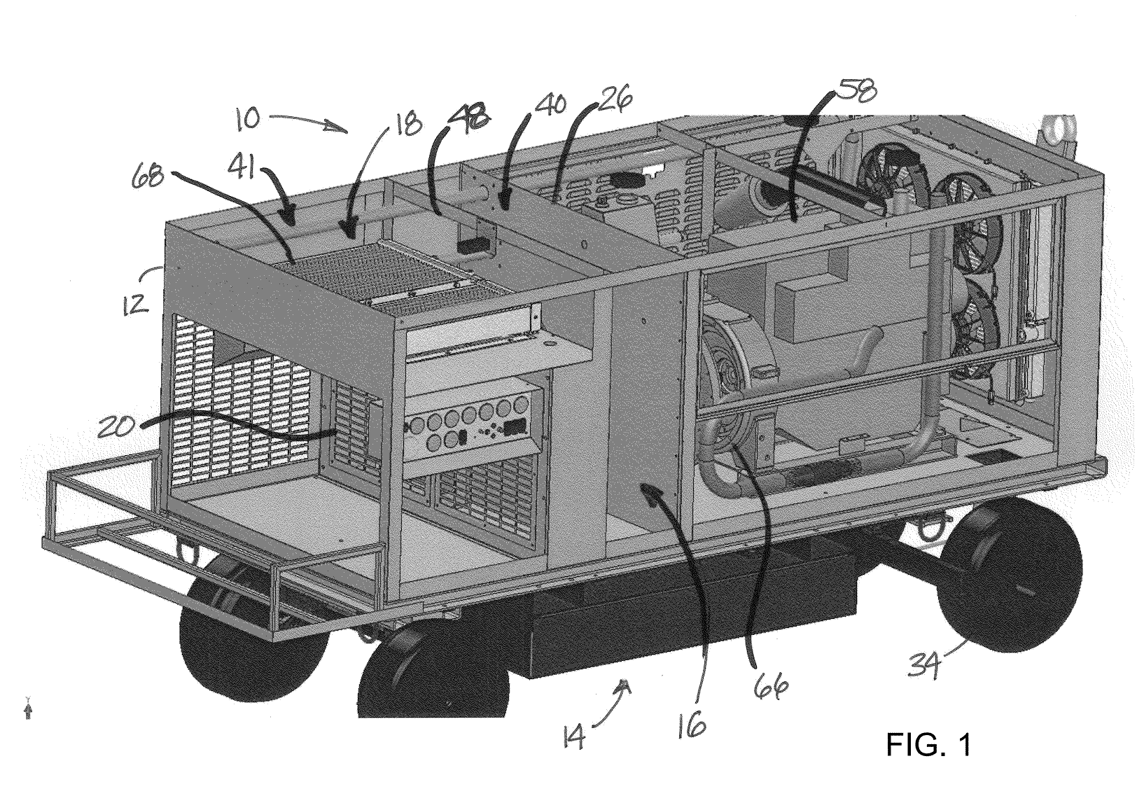

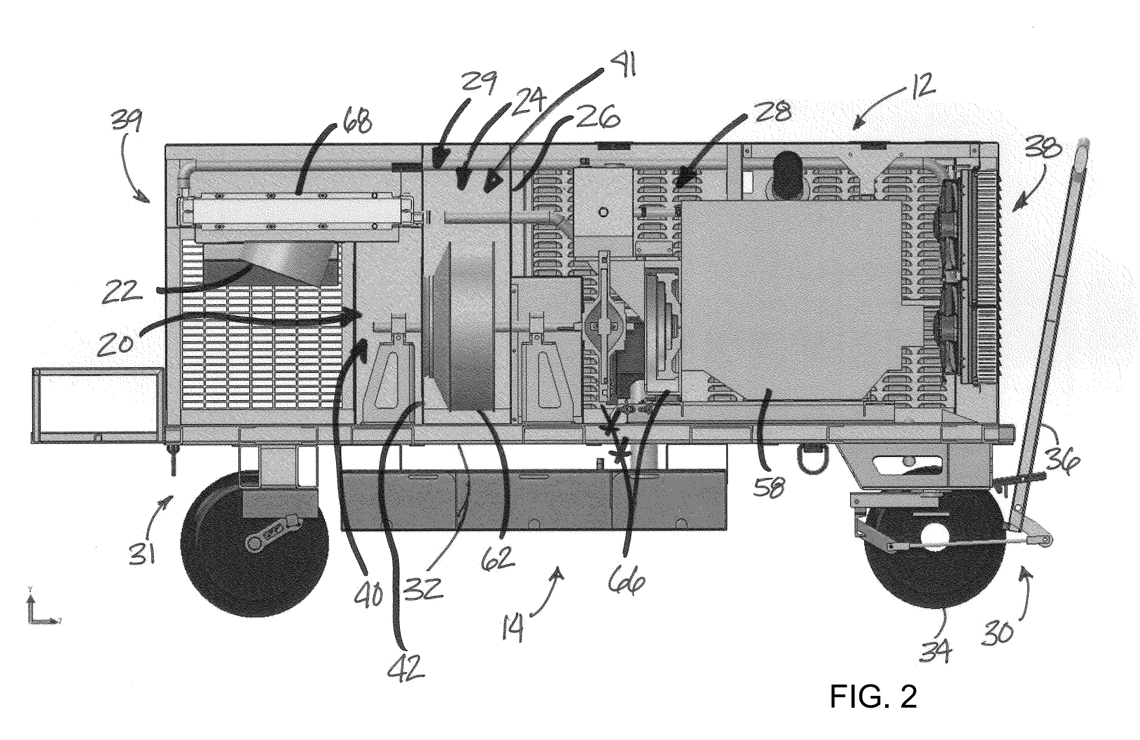

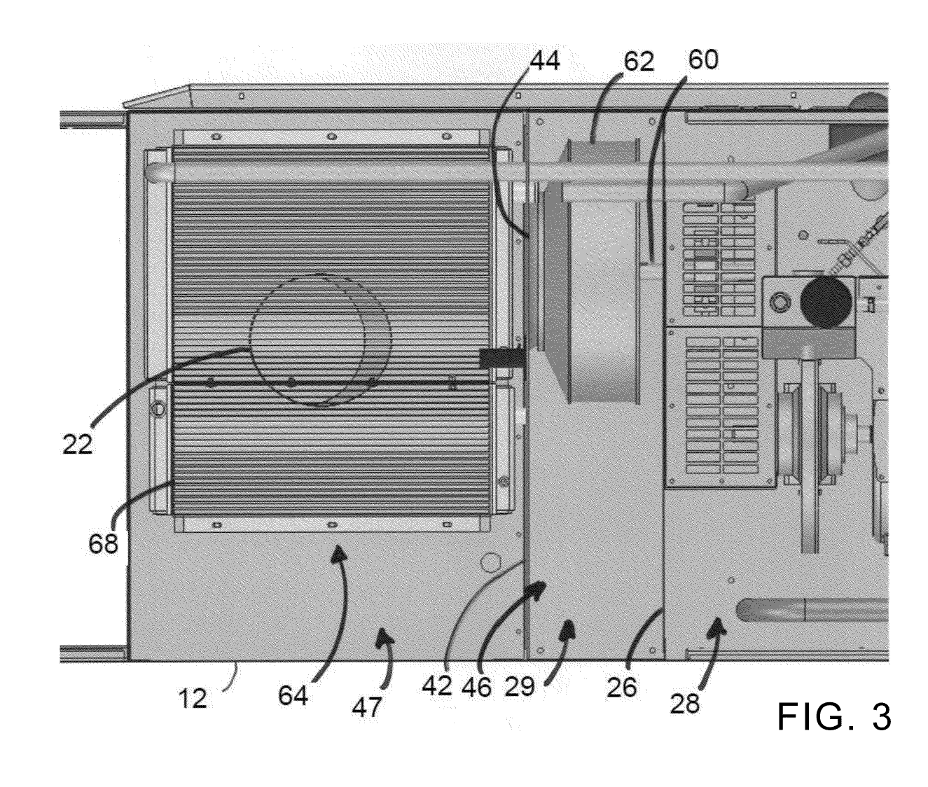

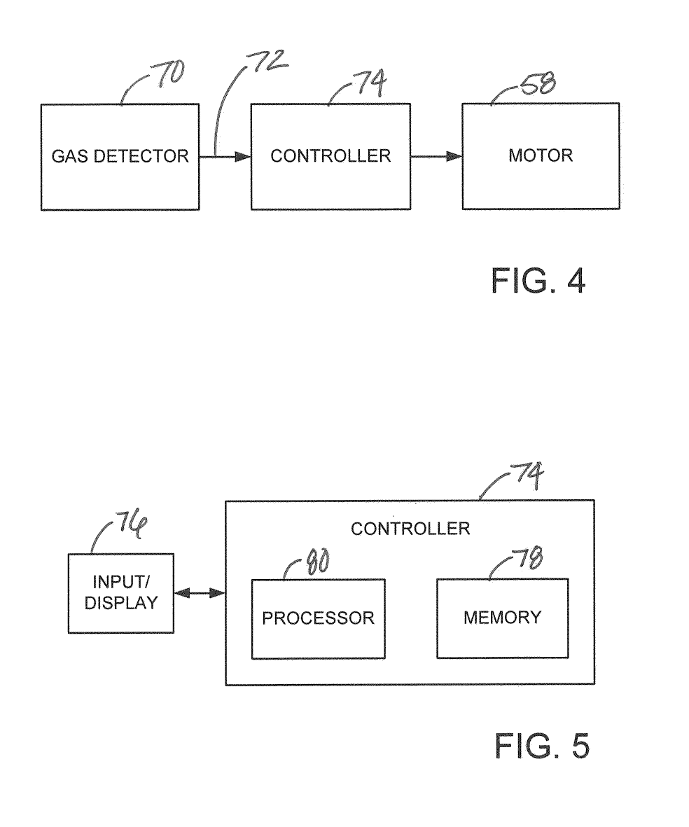

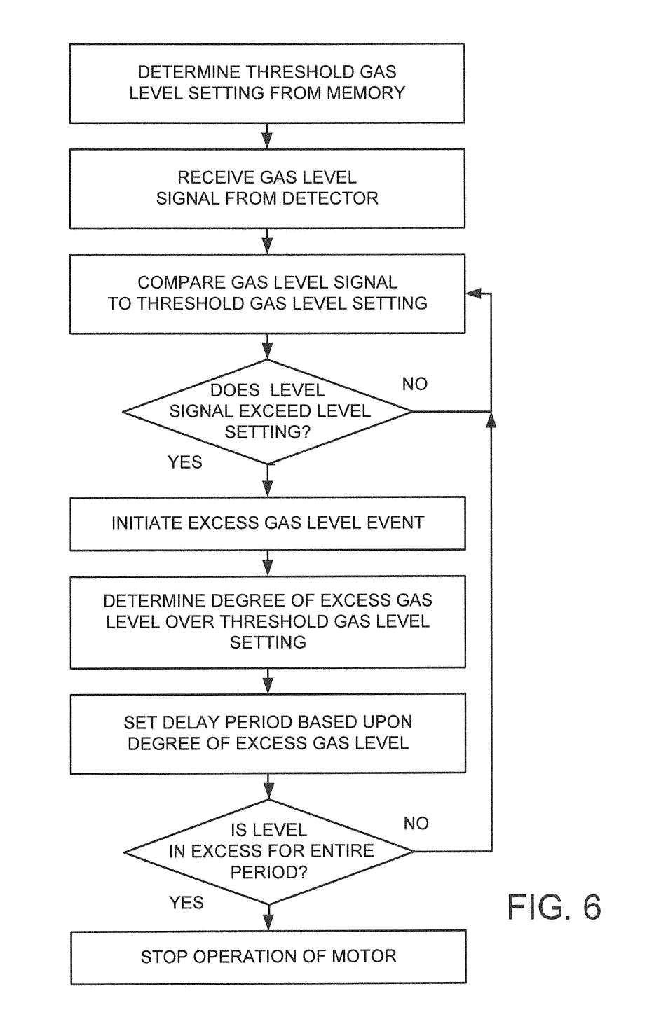

With reference now to the drawings, and in particular to FIGS. 1 through 6 thereof, a new air heating apparatus useful for heating an aircraft interior embodying the principles and concepts of the disclosed subject matter will be described.

Applicants have recognized that external heating apparatus are useful and efficient for the heating an aircraft interior on the ground as an alternative to using one of the propulsion engines or an auxiliary power unit on the plane, especially heating apparatus utilizing “flameless” technology. Applicants also recognize that the use of external heaters may introduce fouled air into the airplane interior. For example, service vehicles operating about the aircraft produce exhaust that may be drawn up by the external heating apparatus and forced into the aircraft interior as heated gases. Even the exhaust of an internal combustion engine used on the heating apparatus itself can become a potential source of undesirable gases if the intake of the apparatus is not properly positioned with respect to the exhaust pipe.

The introduction of fouled gases into the aircraft interior can be problematic, and not just for concerns of smell. Commercial airplanes are typically equipped with a carbon monoxide (CO) detector that monitors the level of carbon monoxide contained in the air within the aircraft interior. Exceeding a threshold level of carbon monoxide in the interior of the airplane, when detected, usually results in the grounding the plane for a not-insignificant period of time in order to determine the source of the carbon monoxide, and may also result in the grounding of the flight crew or others who may be in the plane at the time that the excess carbon monoxide level is detected. Clearly such an event can be expensive and disruptive of schedules.

Applicants have recognized that introduction of air fouled with excessive levels of carbon monoxide into the airplane interior by the heating apparatus can trigger the carbon monoxide detector in the airplane and thus cause the temporary loss of the usage of the airplane as well as the availability of flight crew or other maintenance personnel. Applicants have also recognized that reliance upon the aircraft's internal carbon monoxide detector to determine if air being supplied by the heating apparatus has excessive levels of carbon monoxide is not an efficient or effective solution to the potential problem of excessive carbon monoxide being moved into the aircraft interior.

Applicants have developed an external air heating apparatus capable of sensing or detecting of carbon monoxide levels in the heated air prior to being introduced into the airplane interior, which is highly advantageous for avoiding air with high carbon monoxide levels from reaching the aircraft interior. However, Output temperatures for such heating apparatus may be up to 180 degrees Fahrenheit or more, and typical carbon monoxide detectors are sensitive and not effective at high temperatures. Even the air temperature within the heating apparatus can reach temperatures of over 120 degrees Fahrenheit up to 150 degrees Fahrenheit or more on the “cold” side of the main heat exchanger, and a special carbon monoxide detector is needed to be utilized in the environment of the air heating apparatus. Further, specialized placement of the detector within the air movement chambers may facilitate detection without damage to the detector.

Applicants have further recognized that not all excess carbon monoxide conditions are equally likely to cause an excess level of the gas in the aircraft cabin. For example, air flow with a short burst or duration of relatively high carbon monoxide level (in excess of a threshold carbon monoxide level) can be as dangerous and undesirable as a relatively lower excess carbon monoxide level maintained over a longer period. Applicants have therefore realized that shutting down the operation of the air heating apparatus is not necessary in all cases where excess levels of carbon monoxide are detected, and that the degree to which the carbon monoxide level exceeds the threshold level as well as the duration of the high carbon monoxide level condition are factors that may be considered in combination with each other in order to determine whether to discontinue supplying heated air to the aircraft interior in order to avoid pushing an excessive amount of carbon monoxide into the aircraft interior which may then trigger the aircraft's internal carbon monoxide detector.

Further, applicants have recognized that when an excessive carbon monoxide is detected in level or duration or combination thereof, that immediate shutdown of the heating apparatus may be highly effective to avoid an excess level of carbon monoxide being able to accumulate in the aircraft interior, particularly in situations where the heating apparatus is providing air at high flow rates and pressures.

Illustrative embodiments of an air heater apparatus 10 are set forth in this disclosure, and may include the aforementioned features and advantages as well as others that will become apparent as the description proceeds.

The apparatus 10 may include a housing 12 that may enclose the various components of the apparatus, although this is not critical. Further, the apparatus may also optionally include a mobile base 14 on which the housing is mounted for providing a degree of portability to the apparatus (see FIGS. 1 through 3). The housing may define an interior 16, and may include a frame with an exterior wall that may be formed by a plurality of panels attached to the frame and that may provide a degree of isolation of the interior from the exterior environment of the apparatus 10. The interior 16 may have an air inlet 20 and an air outlet 22, with an air path 18 in the interior extending between the upstream air inlet and the downstream air outlet. The air inlet 20 and the air outlet 22 may each include an opening formed in an exterior wall of the housing. A passage through the housing may define the air path. The housing 12 may have an isolating wall dividing the interior 16 into a first chamber 28 and a second chamber 29, and air in the second chamber may be isolated from air in the second chamber.

The housing 12 may be mounted on the mobile base 14, and the mobile may have a front 30 and a rear 31, and may include a platform 32. A plurality of wheels 34 mounted on axles mounted on the platform. A drawbar 36 may be positioned toward the front 30 of the platform and may be configured for hitching to a towing vehicle to tow the heater apparatus 10. The drawbar 36 may be pivotable upwardly and downwardly, and in some embodiments the pivoting of the drawbar may be used to actuate a brake so that pivoting the drawbar upwardly causes the brake to resist rotation of at least one of the wheels, and pivoting the drawbar downwardly causes the brake to release the resistance.

In some embodiments, the housing 12 may be elongated between the front 28 and the rear 29 of the mobile base, and the housing may have a front end 38 and a rear end 39. In some of the more highly preferred embodiments, the openings of the air inlet 20 and the air outlet 22 may be located toward the rear end 39 of the housing.

The second chamber 39 may be divided or separated into an upstream section 40 and a downstream section 41, with the upstream section being located toward the air inlet 20 and the downstream section being located toward the air outlet 22. The air path 18 thus extends first through the upstream section 40 and then to the downstream section 41. A divider wall 42 may be provided in the housing 12 between the upstream 40 and downstream 41 sections of the second chamber 19 to create a separation therebetween, and may be generally vertically oriented. A transfer opening 44 may be formed in the divider wall to permit air to flow between the upstream 40 and downstream 41 sections and may thus form a portion of the air path 18. Additionally, the downstream section 41 of the housing may also include an initial portion 46 and a final portion 47, the final portion being in communication with the initial portion by an intermediate opening 48 to permit air to move between the portions and form a portion of the air path 18.

In some embodiments, an intake hose may be removably coupled to the housing at the air inlet 20, and may have a free intake hose end for positioning at a source of air that is likely to be relatively free of fumes and other carbon monoxide sources, and a fixed intake hose end removably coupled to the air inlet of the housing. Additionally an outlet hose removably coupled to the housing at the air outlet 22, and may have a fixed outlet hose end removably coupled to the air outlet of the housing and a free outlet hose end for positioning at an interior air supply opening on for an aircraft.

The apparatus 10 may also include a motor 58 for operating various elements of the apparatus 10. The motor 58 is located in the interior 16 of the housing, and may be located in the first chamber 28 of the housing. In some of the most preferred embodiments of the apparatus, the motor comprises an internal combustion engine outputting power through a driven shaft 58

The apparatus 10 may further comprise a fan 62 that is positioned in the air path 18 and may be configured to drive air along the air path. The fan 62 may be configured in the housing interior 16 to pull air into the interior through the air inlet 20 and push air out of the interior through the air outlet 22. The fan may be positioned adjacent to the transfer opening 44 to pull air from the upstream section 40 and push air to the downstream section 41 so that the downstream section has a higher static air pressure than the upstream section. The fan may be located in the interior of the downstream section 41, although this is not critical, and may be located in the initial portion of the downstream section. The fan may comprise a centrifugal fan, although this is also not critical and other suitable types of fans may be employed.

The apparatus 10 may also include an air heating assembly 64 that may be configured to heat air moving along the air path 18 between the inlet 20 opening and the outlet 22 opening. The air heating assembly 64 may be positioned in the housing interior 16 of the housing. The air heating assembly 64 may comprise a heat generator 66 for generating heat in a fluid from rotation energy, and the heat generator may be operatively connected to the engine such that the engine transfers rotation energy to the generator 66, such as through the driven shaft 60. The heat generator 55 may be located in the first chamber 28 of the housing so that the generator is located with the motor and generally isolated from the second chamber. In some of the most preferred embodiments, the heat generator generates heat using a viscous fluid, and the viscous fluid may comprise an oil. One suitable manner of generating heat using a viscous liquid is disclosed in U.S. Pat. No. 5,819,724 which is hereby incorporated in its entirety.

The air heating assembly 64 may also include a heat exchanger 68 that is configured to transfer heat generated by the heat generator 66 to the air flowing along the air path 18. The heat exchanger 68 may be positioned in the second chamber 29 of the housing 12, such that the heat generator and the heat exchanger are in different chambers. The heat exchanger 68 may be in fluid communication with the heat generator 66 so that the heat exchanger receives the heated fluid from the heat generator, and the heat is transmitted to the structure of the heat exchanger and then to the air passing through the exchanger. The heat exchanger may be located in the downstream section 41 of the second chamber, and may be located in the final portion 47 of the downstream section. The heat exchanger may be positioned adjacent to the air outlet 22 of the housing.

The air heater apparatus 10 may include a gas detector 70 that is positioned in or adjacent to the air path 18 in the interior of the housing and configured to detect a gas level in the air of the air path. The gas detector 70 may be configured to detect the level of carbon monoxide in the air passing by and through the detector. The detector 70 may generate a gas level signal 72 corresponding to a gas level detected by the detector, the gas detector being located upstream of the heat exchanger. Significantly, the gas detector 70 may be located in the downstream section 41 of the second chamber 29, and the gas detector may be located in the final portion 47 of the downstream section 41. Generally, the detector may be positioned in the downstream section with a relatively low flow velocity, such that the flow of air in the flow path moving fastest or with the greatest volume does not directly contact or pass over the case of the detector or is not forced through the case of the detector. Suitable detectors may be adapted to endure relatively high temperatures, such as temperatures up to approximately 130 degrees Fahrenheit or more. One example of a suitable carbon monoxide detector is Model no. 353-201-GPU available from Guardian Avionics of 1951 East Airport Dive, Tucson, Ariz. 85706.

The apparatus 10 may also include a controller 74 which may be in communication with the gas detector 70 to receive the gas level signal generated by the gas detector. The controller 74 may be connected to the motor 58 in a manner such that the controller 74 is able to stop operation of the motor by turning the motor off. In the embodiments in which the motor is an internal combustion engine, the controller may effectively cut off power to the ignition system or shut off a fuel pump, as some illustrative examples.

The controller 74 may be configured to receive at least one threshold gas level setting, such as from a user-accessible input 76, that may be stored in memory 78, or optionally the threshold gas level may be relatively permanently set on the apparatus 10 by the factory. More than one threshold level may be set and stored for triggering various actions. The controller 74 may include a processing capability, such as via a processor 80 that is able to monitor the gas level signal and access the one or more threshold gas level settings, and may be configured or programmed such that when the gas level signal is sensed to exceed a threshold gas level, an excess gas level event is initiated. In some implementations, the initiation of the excess gas level event may result in the controller causing the motor to stop operation substantially immediately.

In some implementations, the duration of the excess gas level event, in which the gas level signal exceeds the threshold gas level setting, may be measured. The controller 74 may be configured to delay stopping operation of the motor for a delay period after receiving the gas level signal exceeding the threshold gas level setting. The delay period may vary with the magnitude or degree that the gas level corresponding to the gas level signal exceeds the threshold gas level setting. For example, if the magnitude of the gas level signal is just slightly above the threshold gas level setting, then the delay period may be relatively longer than if the magnitude that the gas level signal exceeds the threshold is relatively greater. Thus, in some implementations, operation of the motor may not be terminated as quickly if the degree to which the threshold gas level setting is exceeded is not large, and conversely if the degree of excess is large, then the motor operation may be stopped more quickly or instantly.

The advantage of such operation is that excess gas level events of short duration and/or low excess level magnitude, which are less likely to cause a significant raising of the gas level in the overall volume of the aircraft interior, may be ignored, or at least do not lead to stopping of the motor. Those events of sufficient duration and/or high excess level magnitude so as to be more likely to raise the gas level in the aircraft interior may cause the motor to be stopped more quickly so that air fouled with the gas is not introduced into the aircraft interior. In some implementations, the controller may be programmed with a number of excess gas levels and corresponding delay periods, with relatively higher gas levels having relatively shorter delay periods and relatively lower gas levels having relatively longer delay periods.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

Further, those skilled in the art will appreciate that the steps shown in the drawing figures may be altered in a variety of ways. For example, the order of the steps may be rearranged, substeps may be performed in parallel, shown steps may be omitted, or other steps may be included, etc.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. An air heater apparatus comprising:
a housing having an interior with an air path extending between an upstream air inlet in the housing and a downstream air outlet in the housing;
a motor mounted on the housing;
a fan rotated by the motor and positioned in the air path to move air along the air path;
an air heating assembly mounted on the housing and configured to heat air moving along the air path; and
a gas detector being positioned in the air path in the interior of the housing and configured to detect a gas level in the air path.

2. The apparatus of claim 1 wherein the gas detector is configured to detect carbon monoxide in the air in the air path.

3. The apparatus of claim 1 wherein the detector generating a gas level signal corresponding to a gas level detected by the detector; and additionally comprising a controller in communication with the gas detector to receive the gas level signal, the controller being configured to stop operation of the motor when the gas level corresponding to the gas level signal exceeds a threshold gas level setting.

4. The apparatus of claim 3 wherein the controller is configured to receive at least one threshold gas level setting.

5. The apparatus of claim 4 wherein the controller is configured such that when the gas level signal exceeds the threshold gas level, an excess gas level event is produced and a duration of the excess gas level event is measured.

6. The apparatus of claim 4 wherein the controller is configured to delay stopping operation of the motor for a delay period after receiving a gas level signal exceeding the threshold gas level setting.

7. The apparatus of claim 6 wherein a length of the delay period varies with a magnitude to which a gas level corresponding to the gas level signal exceeds the threshold gas level setting.

8. The apparatus of claim 7 wherein the controller is configured to stop operation of the motor only after the gas level signal exceeds the at least one threshold gas level for an entirety of the delay period corresponding to the magnitude that the gas level corresponding to the gas level signal exceeds the threshold gas level setting.

9. The apparatus of claim 7 wherein the controller is configured to adjust a length of the delay period based upon a degree that the gas level corresponding to the gas level signal exceeds the threshold gas level setting.

10. The apparatus of claim 9 wherein the length of the delay period is relatively greater when the degree to which the gas level exceeds the threshold gas level setting is relatively lower and is relatively lesser when the degree to which the gas level exceeds the threshold gas level setting is relatively greater.

11. The apparatus of claim 1 wherein the air heating assembly comprises a heat generator generating heat in a fluid and a heat exchanger configured to transfer heat generated by the heat generator to air flowing along the air path.

12. The apparatus of claim 11 wherein the heat generator is configured to generate heat in a viscous fluid from rotation energy, the heat generator being operatively connected to the motor such that the motor transfers rotation energy to the generator.

13. The apparatus of claim 1 wherein the gas detector is located upstream of the heat exchanger in the air path.

14. The apparatus of claim 1 wherein the housing has an isolating wall dividing the interior into a first chamber and a second chamber such that air in the second chamber is isolated from air in the first chamber, the air path being formed by a passage in the second chamber.

15. The apparatus of claim 14 wherein the motor and a heat generator of the air heating assembly are located in the first chamber.

16. The apparatus of claim 1 wherein the housing is mounted on a mobile base having a front and a rear, the mobile base including a platform, a plurality of wheels mounted on axles mounted on the platform, and a drawbar positioned toward the front of the platform and being configured for hitching to a towing vehicle to tow the heater apparatus.

17. The apparatus of claim 1 wherein the motor comprises an internal combustion engine.
